(19) United States
(12) Patent Application Publication
(10) Pub. No.: US 2026/0004117 A1
(43) Pub. Date: Jan. 1, 2026

(54) USING A MOSFET AS A LAYER OF A MACHINE LEARNING NETWORK

(71) Applicant: Micron Technology, Inc., Boise, ID (US)

(72) Inventors: Paul Henry Chandler SMITH, Boise, ID (US); Mark Edward BAUER, Boise, ID (US)

(21) Appl. No.: 19/249,058

(22) Filed: Jun. 25, 2025

Related U.S. Application Data
(60) Provisional application No. 63/665,235, filed on Jun. 27, 2024.

(51) Int. Cl. G06N 3/065; G06N 3/048

(52) U.S. Cl. CPC G06N 3/065; G06N 3/048

(57) ABSTRACT

In some implementations, a machine learning device may perform, using a metal-oxide-semiconductor field-effect transistor (MOSFET), a computation of a machine learning network, wherein performing the computation of the machine learning network includes: using the MOSFET to implement an activation function of the computation, and performing at least one of: adjusting a transconductance of the MOSFET to modulate a weight of the computation, or adjusting a threshold voltage of the MOSFET to modulate a bias of the computation.

### CROSS-REFERENCE TO RELATED APPLICATION

This Patent application claims priority to U.S. Provisional Patent Application No. 63/665,235, filed on Jun. 27, 2024, entitled “USING A MOSFET AS A LAYER OF A MACHINE LEARNING NETWORK,” and assigned to the assignee hereof. The disclosure of the prior Application is considered part of and is incorporated by reference into this Patent Application.

### TECHNICAL FIELD

The present disclosure generally relates to machine learning networks. For example, the present disclosure relates to using a metal-oxide-semiconductor field-effect transistor (MOSFET) as a layer of a machine learning network.

### BACKGROUND

Machine learning networks encompass a broad category of algorithms designed to enable computers to learn patterns and make predictions from data without being explicitly programmed. These networks are modeled after the structure and function of biological neural networks, hence often referred to as artificial neural networks (ANNs). ANNs consist of interconnected nodes, or neurons, organized into layers. Data is fed into the input layer, processed through hidden layers using weighted connections, and produces an output in the final layer, often used for classification, regression, or other predictive tasks. Popular types of ANNs include feedforward neural networks, recurrent neural networks (RNNs), convolutional neural networks (CNNs), and generative adversarial networks (GANs), each tailored for specific tasks such as sequential data analysis, image recognition, and generative modeling.

Deep learning, a subset of machine learning networks, involves ANNs with many layers that allow for hierarchical feature learning, facilitating the extraction of intricate patterns from complex data. These deep architectures may be implemented in various fields such as computer vision, natural language processing, and speech recognition. In some examples, advancements in deep learning include the development of deep convolutional networks for image classification tasks, recurrent networks for sequential data processing, and transformer models for language understanding and generation. Deep learning networks may be used to solve increasingly complex real-world problems across industries.

### BRIEF DESCRIPTION OF THE DRAWINGS

FIG. 1 is a diagram of an example apparatus associated with techniques described herein.

FIGS. 2A-2B are diagrams illustrating example Adaline and Madaline layers in machine learning networks.

FIGS. 3A-3G are diagrams of an example associated with analog Adaline devices and/or analog Madaline devices, according to some implementations.

FIG. 4 is a flowchart of an example method associated with using a MOSFET as a layer of a machine learning network.

FIG. 5 is a flowchart of an example method of forming a semiconductor device for performing a computation of a machine learning network.

### DETAILED DESCRIPTION

In some examples, general purpose engines (e.g., central processing units (CPUs) and/or graphics processing unit (GPUs), among other examples) may be used for performing complex operations, such as CPUs and/or GPUs that are used for implementing machine learning networks. In some examples, machine learning networks may implement an adaptive linear neural (Adaline) network, which may include weighting multiple inputs, summing the weighted inputs, and/or passing the summed weighted inputs through an activation function, such as a rectified linear unit (ReLU) function or a similar activation function. Moreover, in any given layer of a machine learning network, two or more Adaline networks may be combined into a multiple Adaline (Madaline) network. In this regard, certain machine learning networks may be relatively complex and/or may scale poorly. For example, a typical complexity of a machine learning network that employs Madaline networks may be O(N³) (e.g., a time it takes to run an algorithm associated with the machine learning network increases at a rate proportional to the cube of the size of the input, N). Put another way, as a size of the input (e.g., N) to the machine learning network grows, a time and/or computational power needed to train and/or run the machine learning network may grow at a cubic rate. In this regard, machine learning tasks may require high power, computing, and memory resource consumption.

In some examples, machine learning networks may be associated with multiple layers of structure used to perform multiply and/or add functions, with the results being passed through an activation function (e.g., the ReLU function described above, among other examples). In this regard, a GPU, a CPU, and/or a similar general purpose engine used to implement a machine learning network may be associated with numerous weight terms, bias terms, or similar terms used at the various layers of the machine learning network. This may require high amounts of data movement in the general purpose engines (e.g., movement of a high volume of weight terms and/or bias terms from memory associated with the GPU, CPU, and/or similar general purpose engine to that is slushed into the GPU, CPU, and/or similar general purpose engine when performing a machine learning operation), leading to high power consumption associated with the numerous transitions in the GPU, CPU, and/or similar general purpose engine.

Some implementations described herein enable reduction in or mitigation of data movement (e.g., reduction of movement of weight terms, bias terms, and/or similar terms) in a machine learning network, such as for a purpose of reducing power consumption in the machine learning network, among other examples. In some implementations, MOSFETs may be used as layers and/or stages in a machine learning network, such as for the purpose of simulating an activation function of a machine learning network. In such implementations, multiple MOSFETs may be used in parallel to perform a machine learning operation. Moreover, weight terms and/or biasing terms may be stored locally at the MOSFETS, thus reducing or removing an amount of data movement within a machine learning network. and thus reducing an amount of power consumption by the machine learning network.

Additionally, or alternatively, in some aspects, a weight value and/or a bias value of a MOSFET may be controllable in order to enable use of a MOSFET as a layer and/or a stage of a machine learning network. For example, some implementations described herein enable electrical modulation of a usable gate area in MOSFET in order to use the MOSFET as a component of an analog machine learning network. For example, some implementations described herein are directed to an analog Adaline and/or Madaline device formed by enabling electrical modulation of a usable gate area in one or more MOSFETs. The analog Adaline and/or Madaline device may be used to perform machine learning tasks, among other operations, at a reduced complexity as compared to traditional machine learning networks and/or with a reduced power, computing, and memory resource consumption as compared to using a CPU and/or a GPU that implements a digital machine learning network.

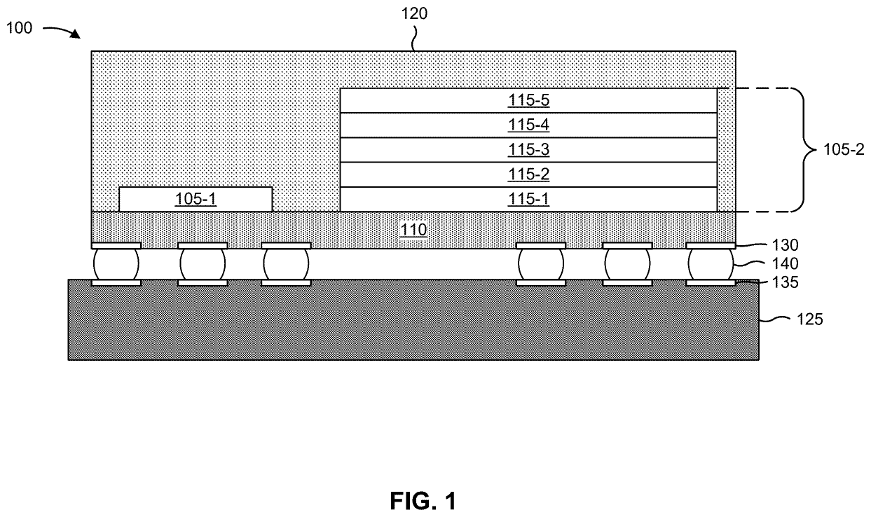

FIG. 1 is a diagram of an example apparatus 100 associated with the techniques described herein. The apparatus 100 may include any type of device or system that includes one or more integrated circuits 105. For example, the apparatus 100 may include a memory device, a flash memory device, a NAND memory device, a NOR memory device, a random access memory (RAM) device, a read-only memory (ROM) device, a dynamic RAM (DRAM) device, a static RAM (SRAM) device, a solid state drive (SSD), a microchip, a machine learning device, and/or a system on a chip (SoC), among other examples. In some cases, the apparatus 100 may be referred to as a semiconductor package, an assembly, a semiconductor device assembly, or an integrated assembly.

As shown in FIG. 1, the apparatus 100 may include one or more integrated circuits 105, shown as a first integrated circuit 105-1 and a second integrated circuit 105-2, disposed on a substrate 110. An integrated circuit 105 may include any type of circuit, such as an analog circuit, a digital circuit, a radiofrequency (RF) circuit, a power supply, a power management circuit, an input-output (I/O) chip, an application-specific integrated circuit (ASIC), a field-programmable gate array (FPGA), and/or a memory device (e.g., a NAND memory device, a NOR memory device, a RAM device, or a ROM device). An integrated circuit 105 may be mounted on or otherwise disposed on a surface of the substrate 110. Although the apparatus 100 is shown as including two integrated circuits 105 as an example, the apparatus 100 may include a different number of integrated circuits 105.

In some implementations, an integrated circuit 105 may include a single semiconductor die 115 (sometimes called a die), as shown by the first integrated circuit 105-1. In some implementations, an integrated circuit 105 may include multiple semiconductor dies 115 (sometimes called dies), as shown by the second integrated circuit 105-2, which is shown as including five semiconductor dies 115-1 through 115-5.

As shown in FIG. 1, for an integrated circuit 105 that includes multiple dies 115, the dies 115 may be stacked on top of each other to reduce a footprint of the apparatus 100. In some implementations, a spacer may be present between dies 115 that are adjacent to one another in the stack to enable electrical separation and heat dissipation. The stacked dies 115 may include three-dimensional electrical interconnects, such as through-silicon vias (TSVs), to route electrical signals between dies 115. Although the integrated circuit 105-2 is shown as including five dies 115, an integrated circuit 105 may include a different number of dies 115 (e.g., at least two dies 115). A first die 115-1 (sometimes called a bottom die or a base die) may be disposed on the substrate 110, a second die 115-2 may be disposed on the first die 115-1, and so on. Although FIG. 1 shows the dies 115 stacked in a straight stack (e.g., with aligned die edges), in some implementations, the dies 115 may be stacked in a different arrangement, such as a shingle stack (e.g., with die edges that are not aligned, which provides space for wire bonding near the edges of the dies 115).

The apparatus 100 may include a casing 120 that protects internal components of the apparatus 100 (e.g., the integrated circuits 105) from damage and environmental elements (e.g., particles) that can lead to malfunction of the apparatus 100. The casing 120 may be a mold compound, a plastic (e.g., an epoxy plastic), a ceramic, or another type of material depending on the functional requirements for the apparatus 100.

In some implementations, the apparatus 100 may be included as part of a higher level system (e.g., a computer, a mobile phone, a network device, an SSD, a vehicle, or an Internet of Things device), such as by electrically connecting the apparatus 100 to a circuit board 125, such as a printed circuit board. For example, the substrate 110 may be disposed on the circuit board 125 such that electrical contacts 130 (e.g., bond pads) of the substrate 110 are electrically connected to electrical contacts 135 (e.g., bond pads) of the circuit board 125.

In some implementations, the substrate 110 may be mounted on the circuit board 125 using solder balls 140 (e.g., arranged in a ball grid array), which may be melted to form a physical and electrical connection between the substrate 110 and the circuit board 125. Additionally, or alternatively, the substrate 110 may be mounted on and/or electrically connected to the circuit board 125 using another type of connector, such as pins or leads. Similarly, an integrated circuit 105 may include electrical pads (e.g., bond pads) that are electrically connected to corresponding electrical pads (e.g., bond pads) of the substrate 110 using electrical bonding, such as wire bonding, bump bonding, or the like. The interconnections between an integrated circuit 105, the substrate 110, and the circuit board 125 enable the integrated circuit 105 to receive and transmit signals to other components of the apparatus 100 and/or the higher level system.

As indicated above, FIG. 1 is provided as an example. Other examples may differ from what is described with regard to FIG. 1.

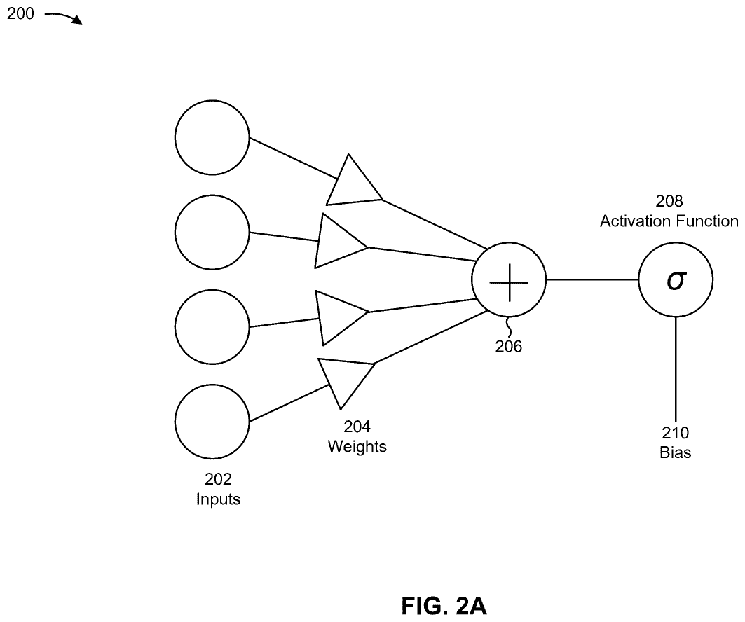

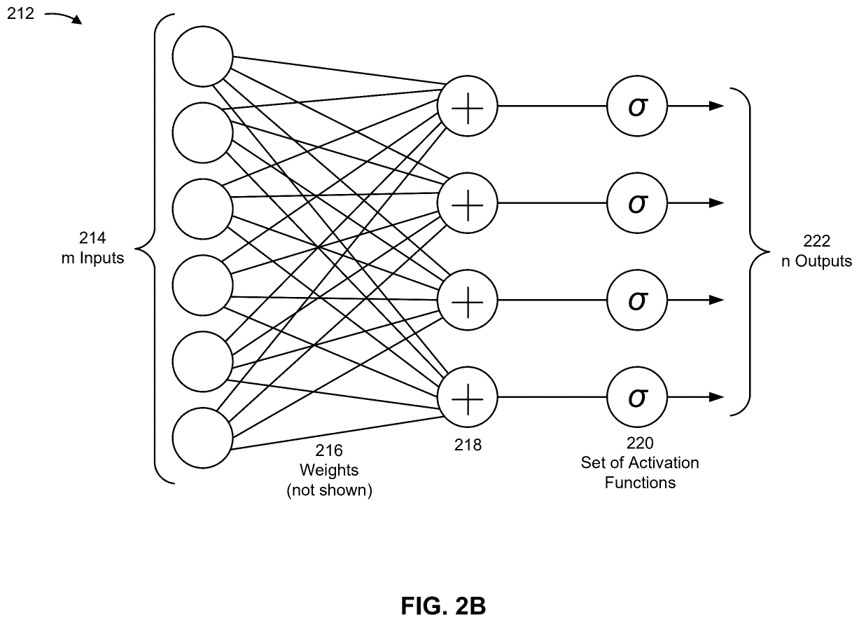

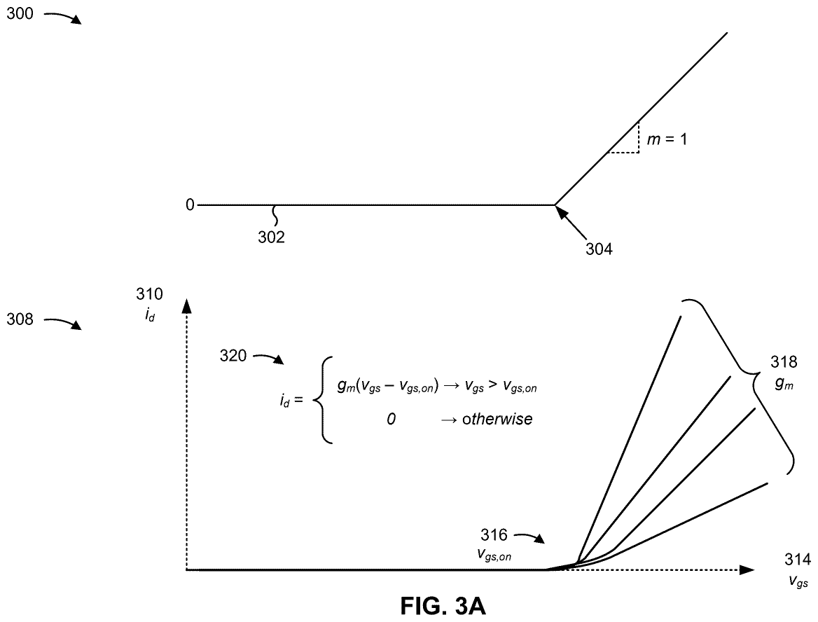

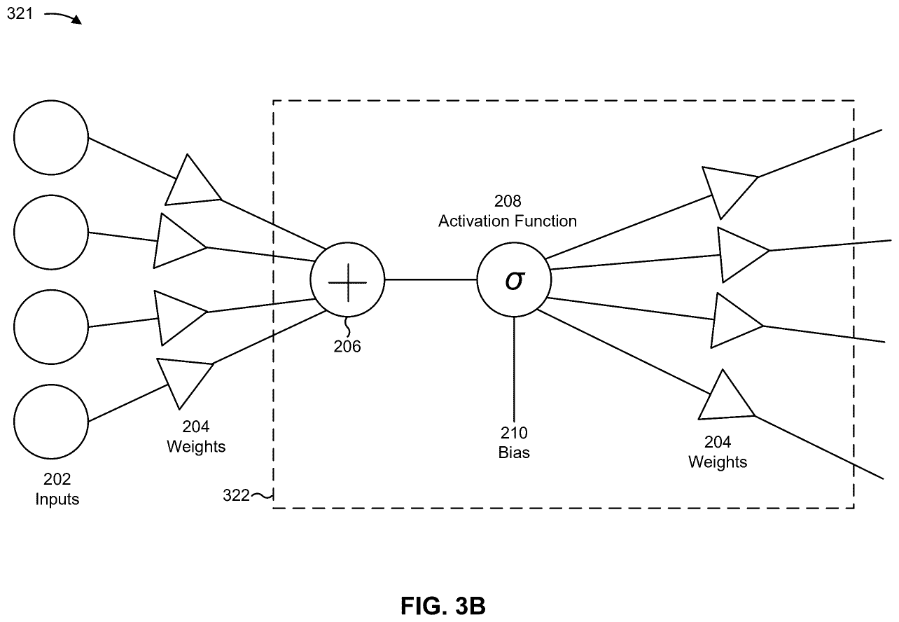

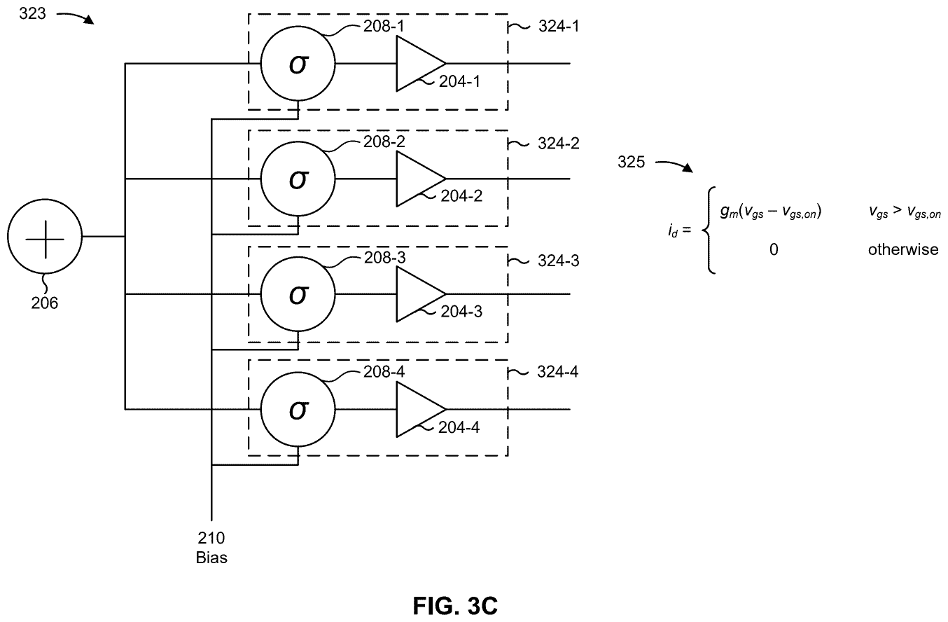

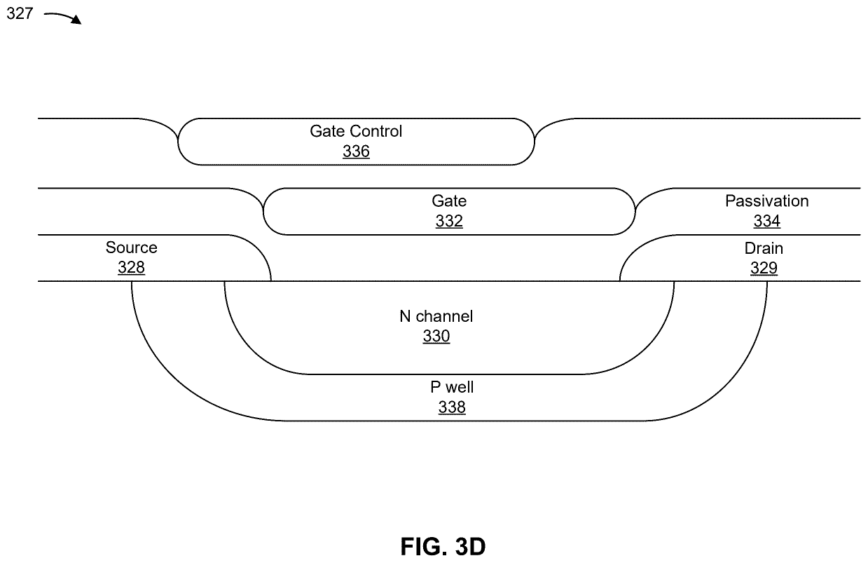

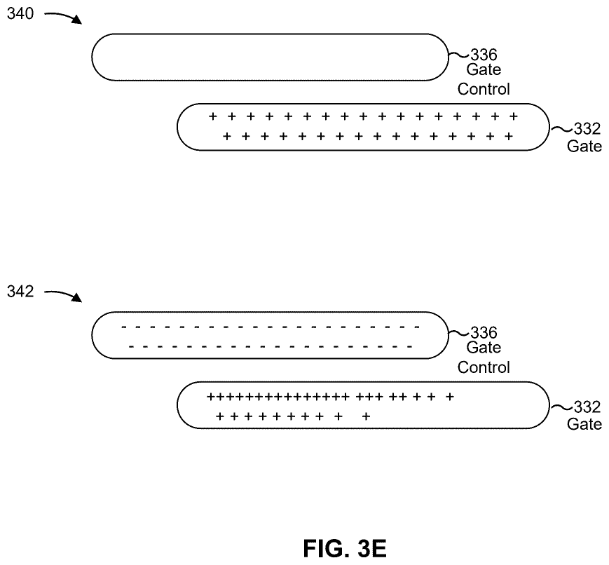

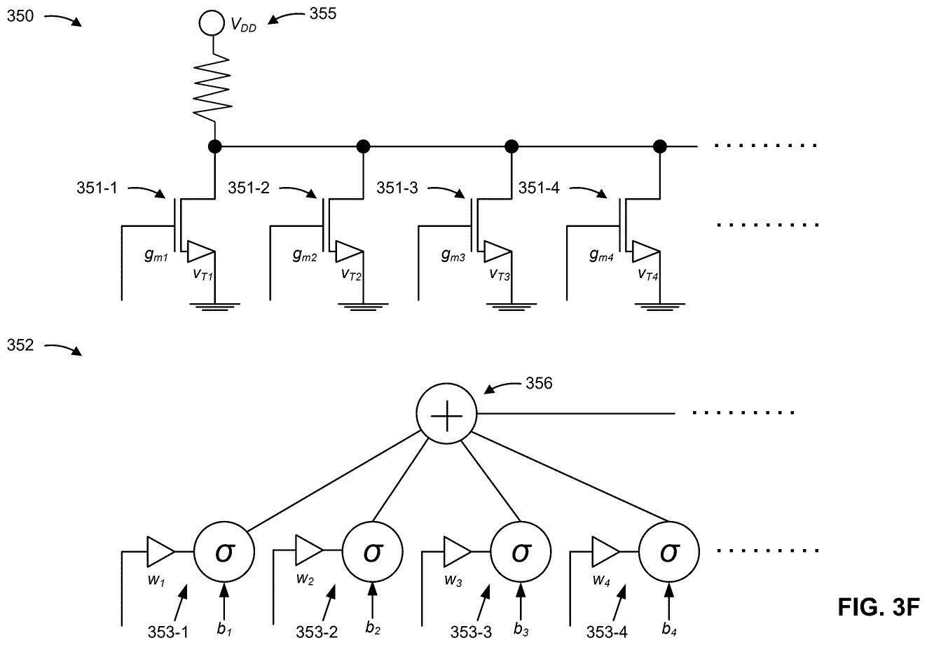

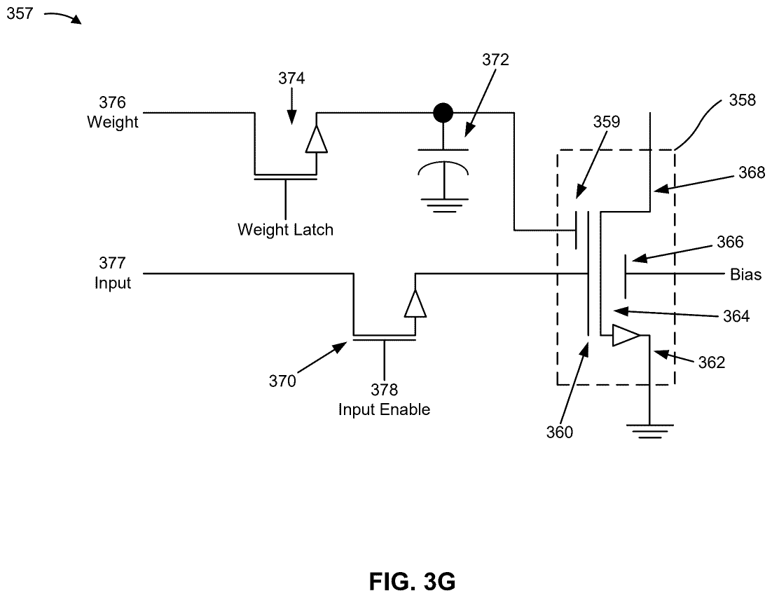

FIGS. 2A-2B are diagrams illustrating example Adaline and Madaline layers in machine learning networks. In some examples, a core structure in a single layer of a machine learning network is an Adaline, such as the example Adaline 200 shown in FIG. 2A. Each Adaline 200 may contain a collection of multiply stages in which inputs 202 are multiplied by weights 204, with the products summed (as shown by summing node 206) to create a single term. The sum may be passed through a non-linear activation function 208 (shown as o in FIG. 2A), which may be any suitable activation function, such as a ReLU or similar activation function (e.g., a linear and/or identity activation function, a non-linear activation function, a sigmoid and/or logistic activation function, a hyperbolic tangent (e.g., Tanh) activation function, or a leaky ReLU activation function, among other examples). The activation function 208 may compute an output for a next stage of a machine learning network. In some examples, a bias 210 may be applied to the activation function, which may have an effect of shifting the activation function 208 (e.g., the ReLU function), which is described in more detail below in connection with FIG. 3A.

Moreover, for any given layer of a machine learning network, two or more Adaline devices may be combined into a Madaline, such as the example Madaline 212 shown in FIG. 2B. The inputs 214 to the Madaline 212 may be inputs to a machine learning network (e.g., in a case of a first Madaline stage), or, for subsequent Madaline stages, the inputs 214 to the Madaline 212 may be output of an activation function (e.g., an output of activation function 220) from a previous Madaline stage in the machine learning network. A Madaline may include a matrix multiplier in which a quantity (e.g., m) of inputs 214 are multiplied by weights 216 (not shown in FIG. 2B, but which may be substantially similar to the weights 204 depicted in FIG. 2A using triangles), with the products of each input summed multiple times to create multiple summed terms, as shown by reference number 218. Each summed term may be fed to a corresponding activation function, of a set of activation functions 220, resulting in a quantity (e.g., n) of outputs 222, which may be used as inputs to next stages of the machine learning network. As described above in connection with FIG. 2A, a bias may be applied to each activation function (not shown in FIG. 2B), which may have an effect of shifting the corresponding activation function (e.g., the corresponding ReLU function). Due to the complexity of the Adaline 200 and Madaline 212 structures, machine learning networks employing such structures may be associated with poor scalability (e.g., due to the network's O(N³) complexity) and/or may require high power, computing, and memory resource consumption.

As indicated above, FIGS. 2A-2B are provided as examples. Other examples may differ from what is described with regard to FIGS. 2A-2B.

FIGS. 3A-3G are diagrams of an example associated with analog Adaline devices and/or analog Madaline devices, according to some implementations.

As shown in FIG. 3A, in some implementations an activation function of an Adaline (e.g., the activation function 208 of the Adaline 200 described above in connection with FIG. 2A) may be a ReLU function, such as the example ReLU function indicated by reference number 300. As indicated by reference number 302, for values below a certain value, such as the value indicated by reference number 304 (which, in some implementations, may be centered at 0 (zero) when no bias is applied to the ReLU function), the ReLU function may return an output of 0. However, for values above the certain value (e.g., the value indicated by reference number 304), the ReLU function may return a value equal to the input value. In some implementations, a derivative of the ReLU function (e.g., 1 (one) for values above the value indicated by reference number 304) may be easy to calculate, which may be beneficial when using a gradient descent method in machine learning networks. In some machine learning networks, multiple ReLU functions may be used in parallel (e.g., with or without weighting applied to each of the multiple ReLU functions), which may be used to piece-wise approximate more complex functions.

As further shown in FIG. 3A, and as indicated by reference number 308, a curve of a drain current (i_{d}) versus a voltage-from-gate-to-source (v_{gs}) for certain transistors, such as MOSFETs or similar transistors, may closely match a curve of a ReLU function, such as the curve of the ReLU function described above in connection with reference number 300. More particularly, the example shows a plot of i_{d}, as indicated by reference number 310, versus v_{gs}, as indicated by reference number 314, for a transistor (e.g., a MOSFET). In such implementations, i_{d} may be equal to zero below a certain v_{gs}, which is sometimes referred to as v_{gs,on} (as indicated by reference number 316), a v_{gs} threshold (sometimes shown as v_{T}), or a similar term. Put another way, v_{gs,on} may correspond to a gate voltage at which current begins to flow through the transistor (e.g., the MOSFET). In some implementations, a slope of the i_{d}-versus-v_{gs} curve (e.g., m) beyond the v_{gs,on} voltage may be controllable by altering properties of the transistor, such as by altering a conductivity of a channel associated with the transistor. For example, as indicated by reference number 318, the transistor may be associated with a certain transconductance (gₘ), which is a ratio between the change in output current and the corresponding change in input voltage of the transistor

$$( e . g . , {g}_{m} = \frac{Δ {i}_{d}}{Δ {v}_{gs}} ) .$$

Put another way, in implementations in which the transistor is a MOSFET, the transconductance (e.g., gₘ) of the MOSFET indicates the sensitivity of the MOSFET to input voltage change. As indicated by reference number 318, a higher gₘ value may result in a steeper slope of the i_{d}-versus-v_{gs} curve following the v_{gs} threshold (e.g., v_{gs,on}), and a lower gₘ value may result in a smaller slope of the i_{d}-versus-v_{gs} curve following the v_{gs} threshold. In that regard, and as indicated by reference number 320, i_{d} may be equal to gₘ×(v_{gs}−v_{gs,on}) when v_{gs}>v_{gs,on}, and i_{d} may be equal to 0 otherwise.

In some implementations, because a curve of a drain current (i_{d}) versus a voltage-from-gate-to-source (v_{gs}) for a MOSFET closely represents an activation function (e.g., a ReLU function) used in a machine learning network, a MOSFET may be used as a layer and/or stage in an analog machine learning network, which may reduce power consumption by the machine learning network as compared to digital machine learning networks, among other benefits. For example, FIG. 3B shows an example 321 of Adaline layer of a machine learning network, which is similar to the Adaline 200 described above in connection with FIG. 2A. In some cases, machine learning networks may have multiple Adalines and/or Madalines in series. More particularly, as shown in the example 321, an output of the activation function 208 (which may be associated with a certain bias 210) may be used as inputs to multiple other stages (e.g., multiple other Adalines) of the machine learning network. In this regard, and as indicated by the broken-line box shown by reference number 322, a layer in a machine learning network may include, following a summing node, an activation function 208 (e.g., a non-linear function) followed by a gain, for a given output.

As shown in FIG. 3C, and as indicated by reference number 323, the structure shown in the broken-line box in FIG. 3B may alternatively be represented using multiple activation functions 208 (shown in FIG. 3C as a first activation function 208-1 through a fourth activation function 208-4), with each activation function 208 being associated with a same bias 210 and/or with each activation function having a single output associated with a corresponding weight (shown in FIG. 3C as a first weight 204-1 through a fourth weight 204-4). In this way, each activation function 208/weight 204 pair may be implemented in an analog machine learning network using a transistor such as a MOSFET 324 (schematically shown in FIG. 3C using broken-line boxes), among other examples. Accordingly, the example machine learning network layer shown by reference number 323 may be implemented using four MOSFETs 324, shown in FIG. 3C as a first MOSFET 324-1 through a fourth MOSFET 324-4.

Put another way, in some implementations, a MOSFET 324 may be used as an analog representation of an activation function and/or a corresponding weight factor, thereby enabling use of the MOSFET 324 in analog machine learning networks (e.g., analog Madaline devices), or the like. In such implementations, and as indicated by reference number 325, an output value of each MOSFET 324 may be equal to gₘ(v_{gs}−v_{gs,on}) when an input voltage (e.g., v_{gs}, which corresponds to a voltage leaving the summing node 206) is greater than a v_{gs} threshold (e.g., v_{gs,on}), and the output value of each MOSFET 324 may be equal to zero otherwise. In such cases, the transconductance (e.g., gₘ) of the MOSFET 324 may map to the weight 204 of the Adaline stage of the machine learning network (sometimes referred to as

$${w}_{j , k}^{i} ) ,$$

the input voltage (e.g., v_{gs}) of the MOSFET 324 may map to an output of a summing node 206 of the Adaline stage of the machine learning network (sometimes referred to as

$${a}_{j}^{i} ) ,$$

and/or the v_{gs} threshold (e.g., v_{gs,on}) of the MOSFET 324 may map to a bias 210 of the Adaline stage of the machine learning network (sometimes referred to as

$${b}_{j}^{i} ) .$$

For example, FIG. 3D shows one example of a modulated transistor 327 that may be used as a single activation function and weight term in an Adaline stage of an analog machine learning network. More particularly, FIG. 3D is a cross-sectional view of the modulated transistor 327 that may be used as an analog Adaline device, such as within a machine learning network, or the like. In some implementations, the modulated transistor 327 may correspond to the MOSFET 324 described above in connection with FIG. 3C. In some implementations, the modulated transistor 327 may include a source terminal 328, a drain terminal 329, and a channel 330 electrically connecting the source terminal 328 to the drain terminal 329. In the example shown in FIG. 3D, the channel 330 may be a negative channel (N channel) (e.g., the modulated transistor 327 may include or otherwise be associated with an N-channel MOSFET), which may be a channel in which a majority of the current carriers are electrons. In some other implementations, a different type of channel may be used, such as a positive channel (P channel), which may be a channel in which a majority of the current carriers are holes, among other examples.

The modulated transistor 327 may further include a gate 332 proximate to the channel 330 (e.g., located above the channel 330 and/or physically separated from the channel 330 via a passivation layer 334). The gate 332 may be a component that is configured to control electrical current (e.g., i_{d}) flowing from the source terminal 328 to the drain terminal 329 via the channel 330 based on a voltage (e.g., v_{gs}) being applied to the gate 332. More particularly, when a voltage (e.g., v_{gs}) applied to the gate 332 exceeds a certain threshold (e.g., v_{gs,on}), electrical current (e.g., i_{d}) may flow between the source terminal 328 and the drain terminal 329 via the channel 330, and/or when no voltage is applied to the gate 332 and/or when a voltage applied to the gate 332 does not satisfy the threshold (e.g., v_{gs}), no electrical current may flow between the source terminal 328 and the drain terminal 329. The extremely high direct current (DC) impedance of the gate 332 may allow many gates 332 to be connected in parallel to a summing node (e.g., summing node 206).

The modulated transistor 327 may further include a gate control component 336 proximate to the gate 332. In some implementations, the gate control component 336 may be physically offset from the gate 332, as shown in FIG. 3D. In this regard, the gate control component 336 may be capable of electrostatically modifying a transconductance of the modulated transistor 327 (e.g., a gₘ of the modulated transistor 327), which is described in more detail below in connection with FIG. 3E. The position of the gate control component 336 may be offset towards the source terminal 328, the drain terminal 329, or offset into or out of the page, or some combination thereof. Moreover, in some implementations, such as implementations in which the channel 330 is an N channel, the modulated transistor 327 may include a positive well (P well) 338 and/or may be disposed in the P well 338 (e.g., the P well 338 may at least partially surround the channel 330). In such implementations, a conductivity of the P well 338 may be controllable in order to modulate a v_{gs} threshold (e.g., v_{gs,on}) associated with the modulated transistor 327. In this regard, when the modulated transistor 327 is used as an analog Adaline device in a machine learning network, a bias of the analog Adaline device may be controllable by modulating the conductivity of the P well 338. In some implementations, such as implementations in which multiple modulated transistors 327 are placed in parallel to form an analog Madaline device and/or in which multiple modulated transistors 327 are used in different layers of a machine learning network (e.g., such as the multiple MOSFETs 324 described above in connection with reference number 323 in FIG. 3C), multiple modulated transistors 327 may be placed in a single P well 338. That is, multiple modulated transistors 327 may have the same bias value (as schematically shown in FIG. 3C), and thus each may be placed in a common P well 338. Put another way, in some implementations, the P well 338 may surround channels 330 of multiple modulated transistors 327 that are associated with the same bias term.

As shown in FIG. 3E, in some implementations, the gate control component 336 may be used to electrically modulate a usable gate area of the gate 332, thereby controlling a transconductance (e.g., gₘ) associated with the modulated transistor 327. More particularly, as indicated by reference numbers 340 and 342, in some implementations the gate control component 336 may be above the gate 332 and/or the gate control component 336 may be physically offset from the gate 332. In this regard, at a first point in time, the gate 332 may be positively charged to a desired voltage, indicated using evenly dispersed plus signs (+). Moreover, at a second point in time, the gate control component 336 may be biased (e.g., negatively charged), indicated using evenly dispersed negative signs (−). This may cause the charge distribution in the gate 332 to change, shown by grouping the plus signs near the left side and top of the gate 332 shown in connection with reference number 342. By changing the charge distribution in the gate 332, a transconductance (e.g., gₘ) of the modulated transistor 327 may be altered, thereby changing a weight value of the analog Adaline device.

Additionally, or alternatively, in some implementations the modulated transistor 327 (more particularly, the gate 332 of the modulated transistor 327) may be electrically isolated during a period of time in which the gate control component 336 modifies the transconductance of the modulated transistor 327 (e.g., during the second period of time indicated by reference number 342). For example, in some implementations, the modulated transistor 327 may be associated with a switch (e.g., switch 370, described in more detail below in connection with FIG. 3G, which may be another transistor, a second MOSFET, and/or the like) capable of electrically isolating the gate 332 of the modulated transistor 327. In such implementations, the switch (e.g., switch 370) may be closed briefly to allow charge to be trapped in the gate 332. Once the switch is opened, a weight bias voltage may be applied to the gate control 336 pulling charge stored on the gate 332 away from the N channel 330, narrowing the effective channel width and thus modulating the gₘ of the modulated transistor 327.

In this way, a transconductance (e.g., gₘ) of the modulated transistor 327 and/or a v_{gs} threshold (e.g., v_{gs,on}) may be controllable in order to achieve a controllable bias (e.g., the v_{gs,on} parameter may be controllable to serve as a controllable bias) and/or a controllable weight (e.g., the gₘ parameter may be controllable to serve as a controllable gain and/or weight). Accordingly, each modulated transistor 327 may serve as an activation function and weight element of an analog Adaline device to be used in a machine learning network or a similar application. Multiple Adaline devices may be constructed and placed in parallel to construct an analog Madaline device.

More particularly, turning to FIG. 3F, reference number 350 shows a schematic circuit diagram of multiple transistors (e.g., multiple modulated transistors 327) operating in parallel, and reference number 352 shows a diagram of a resulting Madaline network that may be achieved by the multiple transistors operating in parallel. For ease of description, the network shown in FIG. 3F includes four transistors 351 (e.g., four instances of the modulated transistor 327, indexed as a first transistor 351-1 through a fourth transistor 351-4 in FIG. 3F) that correspond to four weight and activation functions (indexed as a first weight and activation function 353-1 through a fourth weight and activation function 353-4 in FIG. 3F) that together service as a portion of a Madaline network, but, in other implementations, similar networks may be employed that include more or fewer transistors 351 and/or weight and activation functions 353. Each transistor 351 may have a controllable transconductance (shown as gₘ₁ through gₘ₄), corresponding to a weight of each weight term (shown as w₁ through w₄), and/or each transistor 351 may have a controllable v_{gs} threshold (shown as v_{T1} through v_{T4}), corresponding to a bias of each activation function (shown as b₁ through b₄). In some implementations, as indicated by reference number 355, the voltages outputted by each transistor may be summed across a resistor or a similar structure, which may correspond to a summing node 356 of the analog Madaline network indicated by reference number 352, and/or which may result in a summation of drain currents (shown above in connection with in FIG. 3B) to be fed as input to another layer of a machine learning network or otherwise used in the machine learning network. The summation of drain currents works against the resistor to produce a voltage at the summing node 356 negatively proportional to the sum of the drain currents. In that regard, stronger signals (e.g., currents) output from the transistors 351 may result in a more negative output. Accordingly, in some implementations, a polarity of the channels 330 of the modulated transistors 327 may be alternated between stages in a machine learning network, such as by alternating between N channel MOSFETs and P channel MOSFETs between a first Madaline stage and a second Madaline stage, among other examples. Additionally, or alternatively, in some implementations, the resistor shown and described in connection with reference number 355 may be replaced by a current mirror (e.g., two transistors), which may work against a resistor to drive the output voltage applied to the next Madaline stage, among other examples.

In some aspects, a weight value used for each transistor 351 (e.g., a value corresponding to each gₘ to be used) may be stored in a storage element, local to the transistors 351. For example, FIG. 3G is a schematic diagram of a semiconductor device 357 for performing a computation of a machine learning network. The semiconductor device 357 may include a transistor 358 (which, in some implementations, may correspond to modulated transistor 327), a gate control component 359 (which, in some implementations, may correspond to gate control component 336), a gate 360 (which, in some implementations, may correspond to gate 332), a source terminal 362 (which, in some implementations, may correspond to source terminal 328), a channel 364 (which, in some implementations, may correspond to channel 330), a bias well 366 (which, in some implementations, may correspond to P well 338), a drain terminal 368 (which, in some implementations, may correspond to the drain terminal 329), a switch 370 (e.g., transistor and/or a MOSFET), a weight storage element 372 (e.g., a capacitive element, such as a DRAM-like capacitive element), and a weight latch 374 (e.g., a MOSFET). In such examples, weight values may be stored using the weight storage element 372, or a similar storage element, and the weight latch 374 may be used to update and/or protect a weight value (e.g., the weight value indicated by reference number 376) stored in the weight storage element 372. Additionally or alternatively, the transistor 358 may be placed directly above and/or below the weight storage element 372 in the semiconductor device 357, thereby reducing power consumption as compared to digital machine learning networks, in which the weight values may be stored in memory and thus moved throughout the machine learning network during machine learning operations. Additionally, or alternatively, in some implementations the weight storage element 372 may be periodically refreshed, similar to a DRAM component. In this regard, the weight data may never need to be moved, just refreshed periodically, resulting in relatively low bandwidth usage for purposes of controlling weights at each transistor 358.

In some implementations, the switch 370 may be capable of electrically isolating the gate 360 of the transistor 358. In such implementations, the switch 370 may be used to enable and/or disable an input 377 to be applied to the gate 360, as indicated by reference number 378. For example, in some implementations, the switch 370 may be closed briefly to allow charge to be trapped in the gate 360. In such implementations, once the switch 370 is opened, a weight bias voltage may be applied to the gate control component 359 pulling charge stored on the gate 360 away from the channel 364, thereby narrowing the effective channel width and thus modulating the gₘ of the transistor 358, in a similar manner as described above in connection with FIG. 3E.

In some implementations, using multiple modulated transistors (e.g., multiple MOSFETs 324, multiple modulated transistors 327, and/or multiple transistors 358) to form an analog Madaline device and/or a machine learning network comprising multiple analog Madaline devices as described above may result in a machine learning network that is associated with a relatively low precision as compared to a machine learning network digitally implemented using a GPU or the like. However, high precision is often not required for many machine learning networks (e.g., a current trend may be toward an 8-bit floating point, or the like), making a machine learning network comprising multiple analog Madaline devices as described above suitable for many machine learning tasks. Additionally, or alternatively, in some implementations a gate of the MOSFET 324, the gate 332 of the modulated transistor 327, and/or the gate 360 of the transistor 358 may be associated with a relatively high DC impedance, which may result in reduced power consumption associated with a machine learning network as compared to digital machine learning networks. In such implementations, a machine learning network comprising multiple analog Adaline and/or Madaline devices as described above may be relatively slow as compared to GPU-based machine learning networks, or the like. However, because some implementations may require a few transistors for each gain term (e.g., the transistor 358 and/or another transistor (e.g., switch 370) to electrically isolate the gate 360 during a period of time in which the gate control component 359 modulates the charge distribution on the gate 360), entire Madaline networks or multiple Madaline networks may be run in parallel, reducing a processing time associated with the machine learning network.

In some implementations, modulating a transconductance (e.g., gₘ) of the MOSFET 324, modulated transistor 327, and/or transistor 358 and/or a v_{gs} threshold (e.g., v_{gs,on}) of the MOSFET 324, modulated transistor 327, and/or transistor 358 may be dependent on process, temperature, and/or similar factors. Accordingly, in some implementations, a semiconductor package may include one or more reference devices used for a purpose of identifying modulation parameters for the MOSFET 324, modulated transistor 327, and/or transistor 358 (e.g., ambient temperature and/or similar parameters) in order to achieve a desired transconductance and/or v_{gs} threshold.

As indicated above, FIGS. 3A-3G are provided as an example. Other examples may differ from what is described with respect to FIGS. 3A-3G.

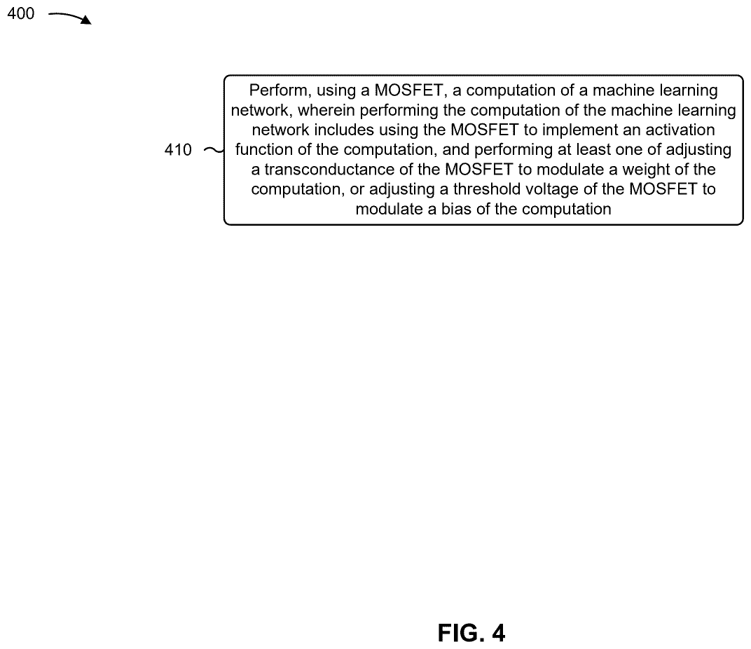

FIG. 4 is a flowchart of an example method 400 associated with using a MOSFET as a layer of a machine learning network. In some implementations, a machine learning device (e.g., a machine learning device associated with one or more of the machine learning network layers described above in connection with reference numbers 323, 350, and/or 352, a machine learning device associated with the modulated transistor 327 and/or transistor 358, and/or a similar machine learning device) may perform or may be configured to perform the method 400. In some implementations, another device or a group of devices separate from or including the machine learning device (e.g., apparatus 100) may perform or may be configured to perform the method 400. Additionally, or alternatively, one or more components of the machine learning device (e.g., a controller associated with one or more integrated circuits 105) may perform or may be configured to perform the method 400. Thus, means for performing the method 400 may include the machine learning device and/or one or more components of the machine learning device. Additionally, or alternatively, a non-transitory computer-readable medium may store one or more instructions that, when executed by the machine learning device, cause the machine learning device to perform the method 400.

As shown in FIG. 4, the method 400 may include performing, using a MOSFET, a computation of a machine learning network, wherein performing the computation of the machine learning network includes: using the MOSFET to implement an activation function of the computation, and performing at least one of: adjusting a transconductance of the MOSFET to modulate a weight of the computation, or adjusting a threshold voltage of the MOSFET to modulate a bias of the computation (block 410). For example, a machine learning device may perform a computation of a machine learning network using the MOSFET 324 described above in connection with FIG. 3C, the modulated transistor 327 described above in connection with FIG. 3D, and/or the transistor 358 described above in connection with FIG. 3G, which may be associated with an adjustable transconductance and/or adjustable threshold voltage, as described above in connection with FIGS. 3D and 3E.

The method 400 may include additional aspects, such as any single aspect or any combination of aspects described below and/or described in connection with one or more other methods or operations described elsewhere herein. For example, method 400 may include additional layer computations (e.g., second layer computations, third layer computations, fourth layer computations, and so forth), or more by repeating the steps described above in connection with block 410.

In a first aspect, the method 400 includes storing, in a storage location local to the MOSFET, at least one of a weight value associated with adjustment of the transconductance of the MOSFET, or a bias value associated with adjustment of the threshold voltage of the MOSFET. For example, the weight value and/or bias value may be stored using a DRAM-like capacitive element or a similar storage element local to the MOSFET, as described above in connection with the weight storage element 372 and the weight latch 374 of FIG. 3G.

In a second aspect, alone or in combination with the first aspect, the method 400 includes periodically refreshing the storage location. For example, in aspects in which the weight value and/or bias value may be stored using a DRAM-like capacitive element, the DRAM-like capacitive element may be periodically refreshed, such as by issuing a refresh command to a controller associated with the DRAM-like capacitive element, among other examples.

In a third aspect, alone or in combination with one or more of the first and second aspects, performing the computation of the machine learning network includes adjusting the transconductance of the MOSFET, and wherein adjusting the transconductance of the MOSFET includes electrostatically controlling a charge distribution at a gate of the MOSFET. For example, the gate control component 336 of the modulated transistor 327 described above in connection with FIG. 3D may be used to modify a transconductance (e.g., gₘ) of the MOSFET, such as in the manner described above in connection with FIG. 3E.

In a fourth aspect, alone or in combination with one or more of the first through third aspects, performing the computation of the machine learning network includes adjusting the threshold voltage of the MOSFET, and adjusting the threshold voltage of the MOSFET includes biasing one of a positive well associated with the MOSFET or a negative well associated with the MOSFET. For example, the modulated transistor 327 may be formed such that a conductivity of the P well 338 is controllable to modulate a v_{gs,on} associated with the modulated transistor 327, as described above in connection with FIG. 3D.

In a fifth aspect, alone or in combination with one or more of the first through fourth aspects, performing the computation of the machine learning network includes adjusting the transconductance of the MOSFET, and adjusting the transconductance of the MOSFET includes electrically isolating a gate of the MOSFET. For example, the switch 370 may be used to electrically isolates the gate 360 of the transistor 358 during a period of time when the gate control component 359 modifies the transconductance (e.g., gₘ) of the transistor 358, as described above in connection with FIG. 3G.

In a sixth aspect, alone or in combination with one or more of the first through fifth aspects, the activation function is a ReLU function. For example, a curve of a drain current (i_{d}) versus a voltage-from-gate-to-source (v_{gs}) for a MOSFET may be used to implement a curve of a ReLU function, as described above in connection with FIG. 3A.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

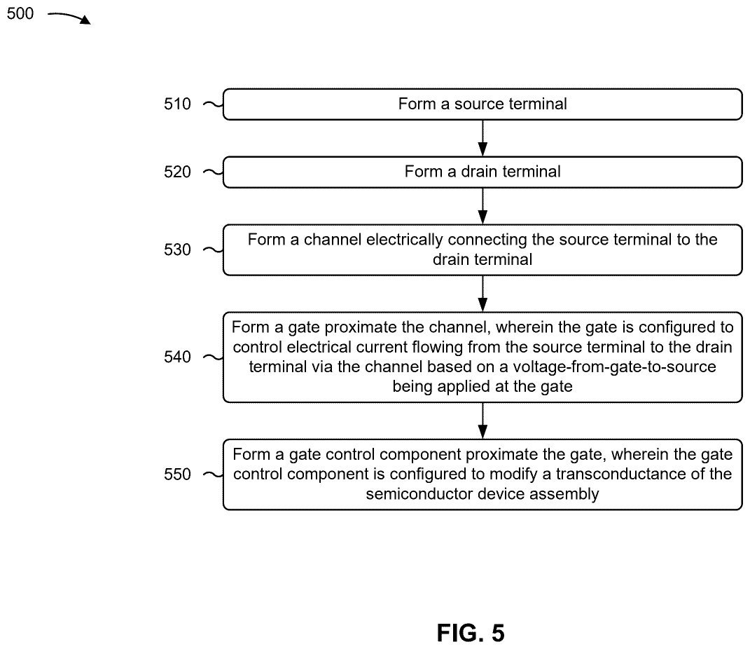

FIG. 5 is a flowchart of an example method 500 of forming a semiconductor device for performing a computation of a machine learning network. In some implementations, one or more process blocks of FIG. 5 may be performed by various semiconductor manufacturing equipment.

As shown in FIG. 5, the method 500 may include forming a source terminal (block 510). For example, the method 500 may include forming the source terminal 328 of the modulated transistor 327 described above in connection with FIG. 3D. As further shown in FIG. 5, the method 500 may include forming a drain terminal (block 520). For example, the method 500 may include forming the drain terminal 329 of the modulated transistor 327 described above in connection with FIG. 3D. As further shown in FIG. 5, the method 500 may include forming a channel electrically connecting the source terminal to the drain terminal (block 530). For example, the method 500 may include forming the channel 330 (e.g., an N channel) of the modulated transistor 327 described above in connection with FIG. 3D. As further shown in FIG. 5, the method 500 may include forming a gate proximate the channel, wherein the gate is configured to control electrical current flowing from the source terminal to the drain terminal via the channel based on a voltage-from-gate-to-source being applied at the gate (block 540). For example, the method 500 may include forming the gate 332 of the modulated transistor 327 described above in connection with FIG. 3D. As further shown in FIG. 5, the method 500 may include forming a gate control component proximate the gate, wherein the gate control component is configured to modify a transconductance of the semiconductor device assembly (block 550). For example, the method 500 may include forming the gate control component 336 of the modulated transistor 327 described above in connection with FIG. 3D, which may be configured to modify a transconductance (e.g., gₘ) of the semiconductor device assembly, such as in the manner described above in connection with FIG. 3E.

The method 500 may include additional aspects, such as any single aspect or any combination of aspects described below and/or in connection with one or more other methods described elsewhere herein.

In a first aspect, the gate control component is offset from the gate. For example, the gate control component 336 of the modulated transistor 327 may be formed to be physically offset from the gate 332, as shown and described above in connection with FIGS. 3D and 3E.

In a second aspect, alone or in combination with the first aspect, the gate is configured to hold a trapped charge, and the gate control component may be configured to modulate a charge distribution of the trapped charge in order to modify the transconductance of the semiconductor device assembly. For example, the gate 332 of the modulated transistor 327 may be configured to hold a trapped positive charge, and the gate control component 336 of the modulated transistor 327 may be capable of being biased (e.g., with a negative charge) in order to modulate a charge distribution of the trapped charge in order to modify the transconductance (e.g., gₘ) of the modulated transistor 327, as described above in connection with FIG. 3E.

In a third aspect, alone or in combination with one or more of the first and second aspects, the channel is one of a negative channel or a positive channel. For example, the channel 330 of the modulated transistor 327 may be an N channel, as shown as described above in connection with FIG. 3D.

In a fourth aspect, alone or in combination with one or more of the first through third aspects, the method 500 includes forming one of a positive well or a negative well at least partially surrounding the one of the negative channel or the positive channel. For example, when the channel 330 of the modulated transistor 327 is the N channel, the method 500 may include forming the P well 338 of the modulated transistor 327 that at least partially surrounds the channel 330 of the modulated transistor 327, as described above in connection with FIG. 3D.

In a fifth aspect, alone or in combination with one or more of the first through fourth aspects, a voltage applied to the one of the positive well or the negative well is controllable to modulate a bias of the computation of the machine learning network. For example, the modulated transistor 327 may be formed such that a conductivity of the P well 338 is controllable to modulate a Ves, on associated with the modulated transistor 327, as described above in connection with FIG. 3D.

In a sixth aspect, alone or in combination with one or more of the first through fifth aspects, the method 500 includes forming a transistor, wherein the transistor is configured to electrically isolate the gate during a period of time when the gate control component modifies the transconductance of the semiconductor device assembly. For example, the method 500 may include forming the switch that electrically isolates the gate 360 of the transistor 358 during a period of time when the gate control component 359 modifies the transconductance (e.g., gₘ) of the modulated transistor 358.

Although FIG. 5 shows example blocks of the method 500, in some implementations, the method 500 may include additional blocks, fewer blocks, different blocks, or differently arranged blocks than those depicted in FIG. 5. In some implementations, the method 500 may include forming the modulated transistor 327 and/or transistor 358, an integrated assembly that includes multiple (e.g., millions or more) modulated transistors 327 and/or transistors 358 (e.g., an analog Madaline device that includes multiple of the modulated transistors 327 and/or transistors 358 operating in parallel, with each modulated transistor 327 and/or transistor 358 serving as an activation function and a weight term of an analog Adaline device), any part described herein of the modulated transistor 327 and/or transistor 358, and/or any part described herein of an integrated assembly that includes one or more modulated transistors 327 and/or transistor 358. For example, the method 500 may include forming one or more of the source terminal 328, the drain terminal 329, the channel 330, the gate 332, the passivation layer 334, the gate control component 336, the P well 338, the gate control component 359, the gate 360, the source terminal 362, the channel 364, the bias well 366, the drain terminal 368, the switch 370, the weight storage element 372, and/or the weight latch 374.

In some implementations, a method includes performing, using a metal-oxide-semiconductor field-effect transistor (MOSFET), a computation of a machine learning network, wherein performing the computation of the machine learning network includes: using the MOSFET to implement an activation function of the computation, and performing at least one of: adjusting a transconductance of the MOSFET to modulate a weight of the computation, or adjusting a threshold voltage of the MOSFET to modulate a bias of the computation.

In some implementations, a machine learning device includes multiple metal-oxide-semiconductor field-effect transistors (MOSFETs) associated with one or more layers of a machine learning network, wherein each MOSFET, of the multiple MOSFETs, is associated with a corresponding weight function and a corresponding activation function; and one or more components configured to: perform, using a MOSFET, of the multiple MOSFETs, a computation of the machine learning network by: using the MOSFET to implement a first weight function and a first activation function of the computation, and performing at least one of: adjusting a transconductance of the MOSFET to modulate a weight of the computation, or adjusting a threshold voltage of the MOSFET to modulate a bias of the computation; and transmit an output current of the MOSFET to a summing node.

In some implementations, a semiconductor device assembly for performing a computation of a machine learning network includes a source terminal; a drain terminal; a channel electrically connecting the source terminal to the drain terminal; a gate proximate the channel, wherein the gate is configured to control electrical current flowing from the source terminal to the drain terminal via the channel based on a voltage-from-gate-to-source being applied at the gate; and a gate control component proximate the gate, wherein the gate control component is configured to modify a transconductance of the semiconductor device assembly to modulate a weight of the computation of the machine learning network.

In some implementations, a method of manufacturing a semiconductor device assembly includes forming a source terminal; forming a drain terminal; forming a channel electrically connecting the source terminal to the drain terminal; forming a gate proximate the channel, wherein the gate is configured to control electrical current flowing from the source terminal to the drain terminal via the channel based on a voltage-from-gate-to-source being applied at the gate; and forming a gate control component proximate the gate, wherein the gate control component is configured to modify a transconductance of the semiconductor device assembly.

The foregoing disclosure provides illustration and description but is not intended to be exhaustive or to limit the implementations to the precise forms disclosed. Modifications and variations may be made in light of the above disclosure or may be acquired from practice of the implementations described herein.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “below,” “beneath,” “lower,” “above,” “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like. All ranges described herein are inclusive of numbers at the ends of those ranges, unless specifically indicated otherwise.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
performing, using a metal-oxide-semiconductor field-effect transistor (MOSFET), a computation of a machine learning network, wherein performing the computation of the machine learning network includes:
using the MOSFET to implement an activation function of the computation, and
performing at least one of:
adjusting a transconductance of the MOSFET to modulate a weight of the computation, or
adjusting a threshold voltage of the MOSFET to modulate a bias of the computation.

2. The method of claim 1, further comprising storing, in a storage location local to the MOSFET, at least one of:
a weight value associated with adjustment of the transconductance of the MOSFET, or
a bias value associated with adjustment of the threshold voltage of the MOSFET.

3. The method of claim 2, further comprising periodically refreshing the storage location.

4. The method of claim 1, wherein performing the computation of the machine learning network includes adjusting the transconductance of the MOSFET, and
wherein adjusting the transconductance of the MOSFET includes electrostatically controlling a charge distribution at a gate of the MOSFET.

5. The method of claim 1, wherein performing the computation of the machine learning network includes adjusting the threshold voltage of the MOSFET, and
wherein adjusting the threshold voltage of the MOSFET includes biasing one of a positive well associated with the MOSFET or a negative well associated with the MOSFET.

6. The method of claim 1, wherein performing the computation of the machine learning network includes adjusting the transconductance of the MOSFET, and
wherein adjusting the transconductance of the MOSFET includes electrically isolating a gate of the MOSFET.

7. The method of claim 1, wherein the activation function is a rectified linear unit (ReLU) function.

8. A machine learning device, comprising:
multiple metal-oxide-semiconductor field-effect transistors (MOSFETs) associated with one or more layers of a machine learning network, wherein each MOSFET, of the multiple MOSFETs, is associated with a corresponding weight function and a corresponding activation function; and
one or more components configured to:
perform, using a MOSFET, of the multiple MOSFETs, a computation of the machine learning network by:
using the MOSFET to implement a weight function and an activation function of the computation, and
performing at least one of:
adjusting a transconductance of the MOSFET to modulate a weight of the computation, or
adjusting a threshold voltage of the MOSFET to modulate a bias of the computation; and
transmit an output current of the MOSFET to a summing node.

9. The machine learning device of claim 8, wherein the one or more components are further configured to:
store, in a storage location local to the MOSFET, at least one of:
a weight value associated with adjustment of the transconductance of the MOSFET, or
a bias value associated with adjustment of the threshold voltage of the MOSFET.

10. The machine learning device of claim 9, wherein the one or more components are further configured to periodically refresh the storage location.

11. The machine learning device of claim 8, wherein the one or more components, to perform the computation of the machine learning network, are configured to adjust the transconductance of the MOSFET, and
wherein the one or more components, to adjust the transconductance of the MOSFET, are configured to electrostatically control a charge distribution at a gate of the MOSFET.

12. The machine learning device of claim 8, wherein the one or more components, to perform the computation of the machine learning network, are configured to adjust the threshold voltage of the MOSFET, and
wherein the one or more components, to adjust the threshold voltage of the MOSFET, are configured to bias one of a positive well associated with the MOSFET or a negative well associated with the MOSFET.

13. The machine learning device of claim 8, wherein the one or more components, to perform the computation of the machine learning network, are configured to adjust the transconductance of the MOSFET, and
wherein the one or more components, to adjust the transconductance of the MOSFET, are configured to electrically isolate a gate of the MOSFET.

14. The machine learning device of claim 8, wherein the activation function is a rectified linear unit (ReLU) function.

15. A semiconductor device assembly for performing a computation of a machine learning network, comprising:
a source terminal;
a drain terminal;
a channel electrically connecting the source terminal to the drain terminal;
a gate proximate the channel, wherein the gate is configured to control electrical current flowing from the source terminal to the drain terminal via the channel based on a voltage-from-gate-to-source being applied at the gate; and
a gate control component proximate the gate, wherein the gate control component is configured to modify a transconductance of the semiconductor device assembly to modulate a weight of the computation of the machine learning network.

16. The semiconductor device assembly of claim 15, wherein the gate is configured to hold a trapped charge, and
wherein the gate control component is configured to modulate a charge distribution of the trapped charge in order to modify the transconductance of the semiconductor device assembly.

17. The semiconductor device assembly of claim 15, wherein the channel is one of a negative channel or a positive channel.

18. The semiconductor device assembly of claim 17, further comprising one of a positive well or a negative well at least partially surrounding the one of the negative channel or the positive channel.

19. The semiconductor device assembly of claim 18, wherein a voltage applied to the one of the positive well or the negative well is controllable to modulate a bias of the computation of the machine learning network.

20. The semiconductor device assembly of claim 15, further comprising a transistor, wherein the transistor is configured to electrically isolate the gate during a period of time when the gate control component modifies the transconductance of the semiconductor device assembly.
